(19) United States
(12) Patent Application Publication
(10) Pub. No.: US 2024/0259285 A1
(43) Pub. Date: Aug. 1, 2024

(54) NETWORK DELAY MEASURING SYSTEM, NETWORK DELAY MEASURING METHOD AND NETWORK DELAY MEASURING DEVICE

(71) Applicant: NIPPON TELEGRAPH AND TELEPHONE CORPORATION, Tokyo (JP)

(72) Inventors: Hiroshi O, Musashino-shi, Tokyo (JP); Kota ASAKA, Musashino-shi, Tokyo (JP); Keita NISHIMOTO, Musashino-shi, Tokyo (JP)

(73) Assignee: NIPPON TELEGRAPH AND TELEPHONE CORPORATION, Tokyo (JP)

(21) Appl. No.: 18/560,933

(22) PCT Filed: May 21, 2021
(86) PCT No.: PCT/JP2021/019438

§ 371 Date: Nov. 15, 2023

(51) Int. Cl. H04L 43/0852

(52) U.S. Cl. CPC H04L 43/0852

(57) ABSTRACT

Delay measurement can be performed by a dedicated circuit without use of software. A delay measurement device includes a general-purpose processor, and a delay measurement circuit that operates according to a pre-installed circuit without use of a program. An opposing terminal communicates with the delay measurement device. The delay measurement circuit includes a measurement packet generation unit, a response packet reception unit, and a delay time calculation unit that are pre-installed. The measurement packet generation unit generates a measurement packet, transmits the measurement packet to the opposing terminal, and stores the transmission time of the measurement packet. The response packet reception unit receives a response packet from the opposing terminal. The delay time calculation unit calculates a reciprocation delay time by subtracting the transmission time from the reception time. The opposing terminal transmits the response packet when receiving the measurement packet.

### TECHNICAL FIELD

The present invention relates to a network delay measurement system, a network delay measurement method, and a network delay measurement apparatus.

### BACKGROUND ART

As disclosed in Non Patent Literature 1, Internet Control Message Protocol (ICMP) is known. The ICMP protocol is used to check a communication state between computers in which TCP/IP is implemented.

Ping is known as a network diagnostic program using the ICMP protocol. In ping, the time from the transmission of an “echo request” ICMP packet to the reception of an “echo reply” ICMP packet is measured as a reciprocation delay time. Ping is designed to measure a reciprocation delay time between two nodes in a network (a configuration in which the ratio between the delay measurement device and the opposing terminal is 1:1).

### CITATION LIST

### Non Patent Literature

Non Patent Literature 1: “Internet Control Message Protocol,” RFC 792, September 1981.

### SUMMARY OF INVENTION

### Technical Problem

Referring now to FIG. 7, the problems in a delay measurement process to be performed by software are described. In FIG. 7, a delay measurement device 70 is connected to an opposing terminal 72 via a computer network 71. Ping is implemented by software, and a delay measurement process is performed in CPUs 73 and 74. The CPUs 73 and 74 are general-purpose processors, and may be required to execute another function implemented by software during a calculation in a delay measurement process. In that case, the delay measurement process is temporarily stopped depending on the priority level of the calculation. This is called interrupt processing.

Since a calculation in a delay measurement process is temporarily stopped due to interrupt processing of another function, an accurate delay time cannot be measured. Furthermore, the CPUs 73 and 74, which are general-purpose processors, do not always have a sufficiently high operation speed and a sufficiently high information transmission speed, and the time required for calculating a delay time is not short enough. As the need for high-speed large-capacity communication increases, a high-speed and high-accuracy delay measurement technology is required as a foundation of information processing. Through high-speed and high-accuracy delay measurement, a fluctuation of a delay occurring in the network is expected to grasp, and the fluctuation is expected to be utilized for network control (such as a route change).

The present invention has been made to solve the problems described above, and aims to provide a network delay measurement system, a network delay measurement method, and a network delay measurement apparatus capable of high-speed and high-accuracy delay measurement.

### Solution to Problem

A first aspect relates to a network delay measurement system.

The network delay measurement system includes a delay measurement device and an opposing terminal. The delay measurement device includes a general-purpose processor that operates according to a loaded program, and a delay measurement circuit that has a lower latency than the general-purpose processor and operates according to a pre-installed circuit without use of the program.

The opposing terminal communicates with the delay measurement device via a computer network.

The delay measurement circuit includes a measurement packet generation unit, a response packet reception unit, and a delay time calculation unit that are pre-installed.

The measurement packet generation unit generates a measurement packet, transmits the measurement packet to the opposing terminal, and stores the transmission time of the measurement packet.

The response packet reception unit receives a response packet from the opposing terminal, and stores the reception time of the response packet.

The delay time calculation unit calculates a reciprocation delay time by subtracting the transmission time from the reception time.

The opposing terminal includes a pre-installed response circuit.

The response circuit transmits the response packet when receiving the measurement packet.

A second aspect relates to a network delay measurement method that uses a delay measurement device and an opposing terminal.

The delay measurement device includes a general-purpose processor that operates according to a loaded program, and a delay measurement circuit that has a lower latency than the general-purpose processor and operates according to a pre-installed circuit without use of the program.

The opposing terminal includes a response circuit that communicates with the delay measurement device via a computer network, and operates according to a pre-installed circuit.

The network delay measurement method includes a measurement packet generation step, a response packet transmission step, a response packet reception step, and a delay time calculation step.

The measurement packet generation step includes generating a measurement packet, transmitting the measurement packet to the opposing terminal, and storing the transmission time of the measurement packet, using the delay measurement circuit.

The response packet transmission step includes transmitting a response packet with the response circuit in a case where the opposing terminal has received the measurement packet.

The response packet reception step includes receiving the response packet from the opposing terminal, and storing the reception time of the response packet, using the delay measurement circuit.

The delay time calculation step includes calculating a reciprocation delay time by subtracting the transmission time from the reception time, using the general-purpose processor or the delay measurement circuit.

A third aspect relates to a network delay measurement apparatus.

The network delay measurement apparatus is a delay measurement device that communicates with an opposing terminal via a computer network.

The network delay measurement apparatus includes a general-purpose processor that operates according to a loaded program, and a delay measurement circuit that has a lower latency than the general-purpose processor and operates according to a pre-installed circuit without use of the program.

The delay measurement circuit includes a measurement packet generation unit, a response packet reception unit, and a delay time calculation unit that are pre-installed.

The measurement packet generation unit generates a measurement packet, transmits the measurement packet to the opposing terminal, and stores the transmission time of the measurement packet.

The response packet reception unit receives a response packet from the opposing terminal, and stores the reception time of the response packet.

The delay time calculation unit calculates a reciprocation delay time by subtracting the transmission time from the reception time.

A fourth aspect relates to a network delay measurement apparatus.

The network delay measurement apparatus is an opposing terminal that communicates with a delay measurement device via a computer network.

The network delay measurement apparatus includes: a response circuit that operates according to a pre-installed circuit; a buffer; and a bifurcating circuit that transmits a received measurement packet to both the response circuit and the buffer.

The response circuit receives the measurement packet from the bifurcating circuit without use of the buffer, and transmits the response packet.

### Advantageous Effects of Invention

According to the present invention, a delay measurement packet and a response packet are generated by a delay measurement circuit and a response circuit that are pre-installed, and no software processing is required. Accordingly, the present invention enables high-speed and high-accuracy delay measurement, without being affected by interrupt processing. By such a technology, it is possible to grasp a fluctuation of a delay occurring in the network, and utilize the fluctuation in network control (such as a route change).

### BRIEF DESCRIPTION OF DRAWINGS

FIG. 1 is a conceptual diagram for explaining an outline of a network delay measurement system according to a first embodiment of the present invention.

FIG. 2 is a conceptual diagram for explaining an outline of a network delay measurement apparatus according to the first embodiment of the present invention.

FIG. 3 is a block diagram illustrating an example configuration of a delay measurement device according to the first embodiment of the present invention.

FIG. 4 is a block diagram illustrating an example configuration of an opposing terminal according to the first embodiment of the present invention.

FIG. 5 is a block diagram illustrating an example configuration of an opposing terminal according to the first embodiment of the present invention.

FIG. 6 is a conceptual diagram for explaining an outline of a network delay measurement system according to a second embodiment of the present invention.

FIG. 7 is a diagram for explaining problems in a delay measurement process by software implementation.

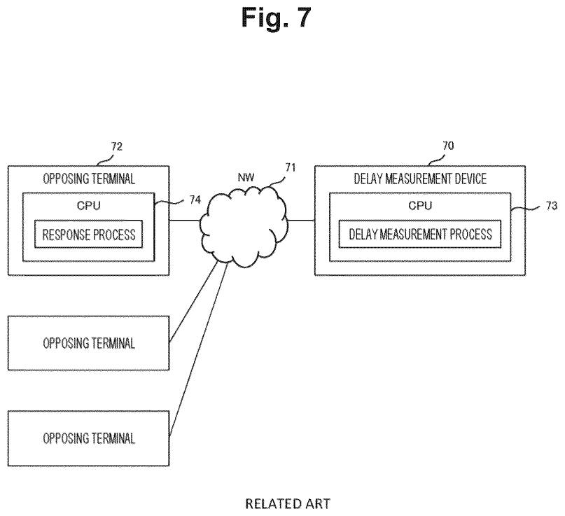

### DESCRIPTION OF EMBODIMENTS

The following is a detailed description of embodiments of the present invention, with reference to the drawings. Note that elements common among the respective drawings are denoted by the same reference numerals, and explanation of them will not be repeated.

### First Embodiment

### (1) Network Delay Measurement System

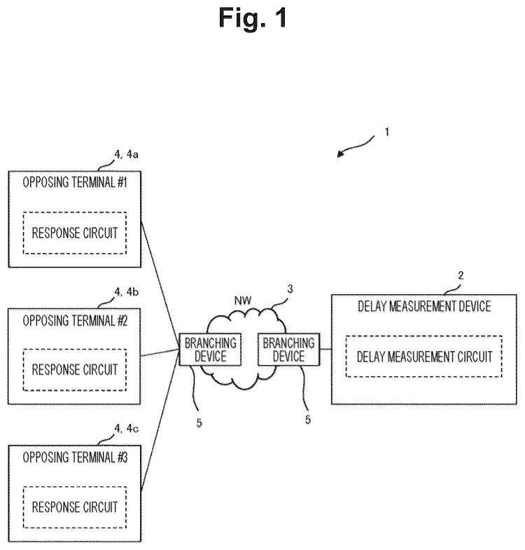

FIG. 1 is a conceptual diagram for explaining an outline of a network delay measurement system according to a first embodiment. A network delay measurement system 1 illustrated in FIG. 1 includes a delay measurement device 2, a computer network 3, at least one opposing terminal 4, and a plurality of branching devices 5. In FIG. 1, a first opposing terminal 4a, a second opposing terminal 4b, and a third opposing terminal 4c are shown as the opposing terminal 4. The delay measurement device 2 and the opposing terminal 4 function as a network delay measurement apparatus.

The delay measurement device 2 is connected to each of the opposing terminals 4 via the branching devices 5 and the computer network 3. The delay measurement device 2 is a device that has a function of measuring a delay time with respect to the opposing terminal 4.

The opposing terminal 4 is a device subjected to delay time measurement. The opposing terminal 4 is a device that has a function of transmitting a response signal (a response packet) in response to a request signal (a delay measurement packet) from the delay measurement device 2. The opposing terminal 4 may be a user end terminal such as a personal computer, or may be a terminal in a network, such as an optical network unit (ONU). The number of the opposing terminals 4 may be one, or may be plural.

The computer network 3 is a wired or wireless network, and may be of any type and scale as a network. An example of the computer network 3 is an optical network.

The branching devices 5 are devices for networking the delay measurement device 2 and the opposing terminals 4. The branching devices 5 are optical switches or optical couplers in an optical network, for example.

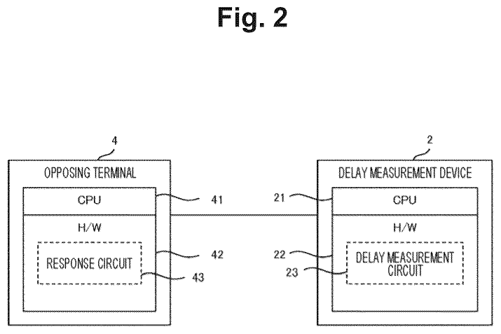

FIG. 2 is a diagram for explaining an outline of a network delay measurement apparatus according to the first embodiment. In FIG. 2, the delay measurement device 2 and the opposing terminal 4 have a 1:1 configuration, but may have a 1:n configuration.

The delay measurement device 2 includes a memory (not illustrated), a CPU 21, and a hardware processing unit 22. The opposing terminal 4 includes a memory (not illustrated), a CPU 41, and a hardware processing unit 42. The CPUs 21 and 41 are general-purpose processors that operate according to a program loaded from the memory. The processing details according to the program are not limited to any specific details. The hardware processing units 22 and 42 are dedicated circuits for delay measurement that operate according to a pre-installed circuit, without use of a program. The hardware processing units 22 and 42 include internal memories. The hardware processing units 22 and 42 each include an FPGA and a GPU, for example. Since the CPUs 21 and 41 communicate via a general-purpose OS or a general-purpose bus, a delay occurs when interrupt processing occurs. However, the hardware processing units 22 and 42 can directly access the data source, and the logic is pre-installed. Thus, a response is returned at a high speed and a constant speed.

Measurement of a delay time between the delay measurement device 2 and an opposing terminal 4 is conducted by a delay measurement circuit 23 and a response circuit 43 that are dedicated circuits.

### (2) Delay Measurement Device

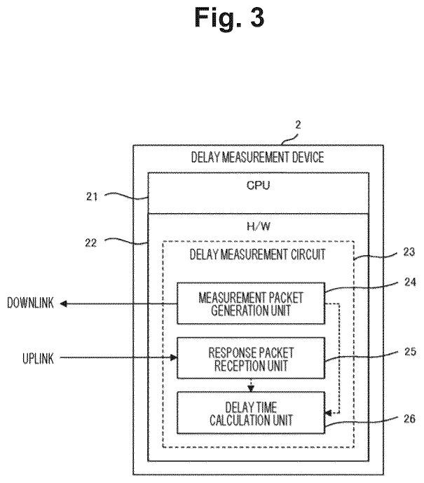

Next, the delay measurement device 2 is described with reference to FIG. 3. FIG. 3 is a block diagram illustrating an example configuration of the delay measurement device 2 according to the first embodiment. The hardware processing unit 22 includes the delay measurement circuit 23 designed as a circuit for delay measurement. The delay measurement circuit 23 mounted in the hardware processing unit 22 is executed without use of the CPU 21.

The delay measurement circuit 23 includes a measurement packet generation unit 24, a response packet reception unit 25, and a delay time calculation unit 26, which are pre-installed.

The measurement packet generation unit 24 generates a delay measurement packet, and transmits the delay measurement packet to an opposing terminal 4. The measurement packet generation unit 24 also stores the transmission time at which the delay measurement packet is transmitted.

The response packet reception unit 25 receives a response packet from the opposing terminal 4, and stores the reception time of the response packet. The transmission time and the reception time are stored in an internal memory in the delay measurement circuit 23, for example.

The delay time calculation unit 26 subtracts the transmission time at which the delay measurement packet has been transmitted from the reception time at which the response packet has been received, and calculates the time required for the reciprocation as a reciprocation delay time.

### (3) Opposing Terminal

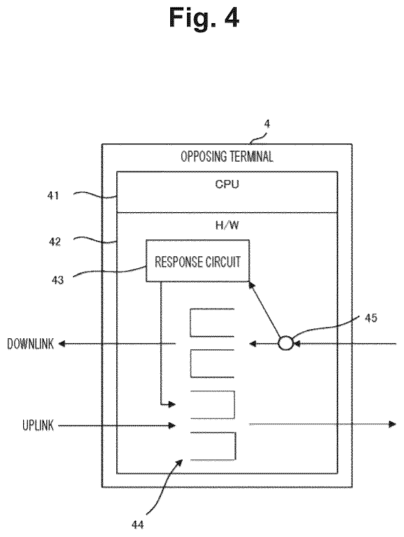

Next, an opposing terminal 4 is described with reference to FIG. 4. FIG. 4 is a block diagram illustrating an example configuration of an opposing terminal 4 according to the first embodiment. The hardware processing unit 42 includes a response circuit 43, a buffer 44, and a bifurcating circuit 45. The response circuit 43 is a circuit designed specially for delay measurement. The circuit mounted in the hardware processing unit 42 is executed without use of the CPU 41.

The buffer 44 includes a downlink buffer and an uplink buffer. The buffer 44 has at least one queue.

The bifurcating circuit 45 is provided on the upstream side of the downlink buffer, and transmits a received delay measurement packet to the response circuit 43 and the buffer 44.

The response circuit 43 receives the delay measurement packet from the bifurcating circuit 45 without use of the buffer 44, and immediately transmits a response packet. That is, the delay measurement packet is input to the response circuit 43 before to the downlink buffer. The response packet is input to the uplink buffer. With this configuration, it is possible to measure a delay time not including a downlink queuing delay of the opposing terminal 4.

### (4) Effects

As described above, in the system of this embodiment, a delay measurement packet and a response packet are generated by a delay measurement circuit and a response circuit that are pre-installed into the system, and no software processing is required. Thus, high-speed and high-accuracy delay measurement can be performed, without being affected by interrupt processing.

### (5) Modification

Next, a modification is described. In the system of the first embodiment described above, the delay time calculation unit 26 is incorporated beforehand into the hardware processing unit 22, to calculate a delay time at a high speed. Meanwhile, the transmission time and the reception time have been grasped by the hardware processing unit 22. Thus, high-accuracy delay measurement can be conducted, even if the processing to be performed by the delay time calculation unit 26 is implemented by software and is performed by the CPU 21. In this case, the transmission time and the reception time may also be stored into a database or the like.

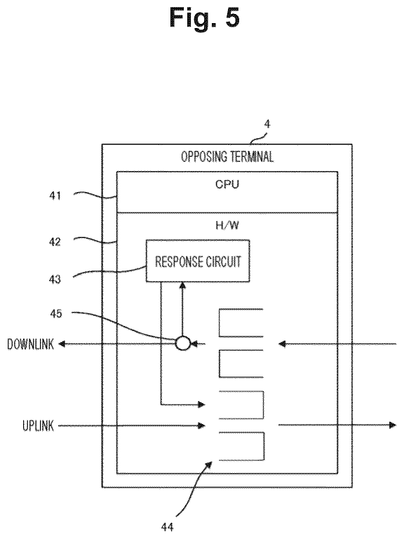

FIG. 5 is a block diagram illustrating another example configuration of an opposing terminal 4. In this example configuration, the bifurcating circuit 45 is provided on the downstream side of the downlink buffer, and sequentially transmits delay measurement packets queued in the buffer 44, to the response circuit 43. With this example configuration, it is possible to measure a delay time including a downlink queuing delay of the opposing terminal 4.

Alternatively, the opposing terminal 4 may not include the buffer 44.

Further, the method for transmitting delay measurement packets and response packets may be an in-band method (a method of transmission involving insertion between data main signals), or an out-of-band method (a method of transmission using a different band from the data main signals). That is, the present invention is not limited to a technique (in-band technique) such as ping.

### Second Embodiment

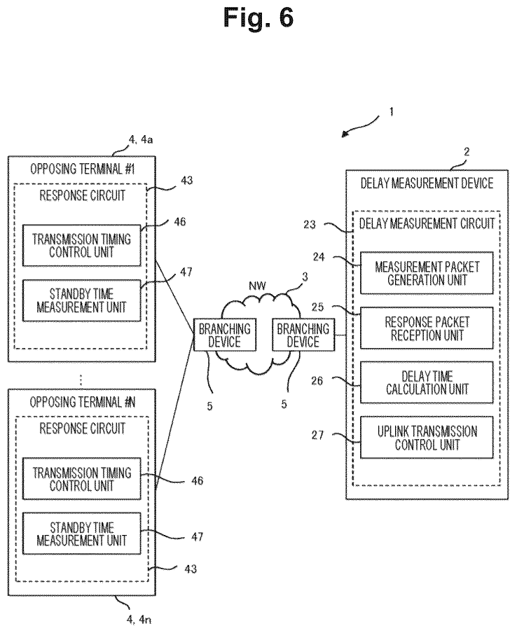

Next, a second embodiment of the present invention is described with reference to FIG. 6. In a case where the present technology is applied to an optical communication system of time division multiple access, there are the following problems.
(A) It is necessary to perform measurement for each of the opposing terminals 4, and the number of packets required for measurement increases with the number of the opposing terminals 4, which strains the band.
(B) A transmission standby delay due to multiple access is included in a measured delay time, and an accurate path delay cannot be measured.

Therefore, in this embodiment, high-speed and high-accuracy delay measurement is to be performed in a system that performs communication in a time-division multiplexing manner.

### (1) Network Delay Measurement System

FIG. 6 is a conceptual diagram for explaining an outline of a network delay measurement system according to the second embodiment. A network delay measurement system 1 according to the second embodiment includes a plurality of opposing terminals 4. In the example illustrated in FIG. 6, one delay measurement device 2 is connected to N opposing terminals 4 (N being an integer of 2 or greater).

The delay measurement device 2 and the opposing terminals 4 communicate in a time-division multiplexing manner. An example of a communication system based on time division multiplexing include a passive optical network (PON). However, network configurations to which the present technology can be applied are not limited to the double star type in a PON.

### (2) Delay Measurement Device

The delay measurement circuit 23 of the delay measurement device 2 according to the second embodiment is partially changed in the processing to be performed by the measurement packet generation unit 24 in the configuration of the first embodiment described above, and newly includes an uplink transmission control unit 27. Note that the uplink transmission control unit 27 may be mounted in another device connected between the delay measurement device 2 and the opposing terminals 4.

The measurement packet generation unit 24 transmits delay measurement packets in a broadcast manner. Note that the measurement packet generation unit 24 may set the plurality of opposing terminals 4 as a group and transmit a delay measurement packet to the group as a destination in a multicast manner, or may transmit a delay measurement packet to each opposing terminal in a unicast manner.

The uplink transmission control unit 27 determines each uplink transmission timing to avoid a collision between uplink transmissions from the first to nth opposing terminals 4a to 4n to the delay measurement device 2. The first to nth opposing terminals 4a to 4n are notified of the respective determined uplink transmission timings.

### (3) Opposing Terminal

The response circuit 43 of each opposing terminal 4 according to the second embodiment further includes a transmission timing control unit 46 and a standby time measurement unit 47 in addition to the components of the first embodiment described above.

The transmission timing control unit 46 performs uplink transmission on the basis of the notified uplink transmission timing.

The standby time measurement unit 47 measures the standby time from the generation of a response packet to the arrival of an uplink transmission opportunity, and adds the standby time to the response packet. The response packet is transmitted to the delay measurement circuit 23.

The delay time calculation unit 26 subtracts the transmission time at which the measurement packet has been transmitted and the standby time from the reception time at which the response packet has been received, and calculates the time required for the reciprocation as a reciprocation delay time.

### (4) Effects

As described above, with the system of this embodiment, the same effects as those of the first embodiment are achieved. That is, according to this embodiment, it is possible to perform high-speed and high-accuracy delay measurement, without being affected by interrupt processing. Also, by measuring the standby time from the generation to the transmission of a response packet, the influence of the transmission standby delay in multiple access can be excluded, and an accurate path delay can be measured. Further, as delay measurement packets are transmitted by in a broadcast or multicast manner, the number of packets and the overhead necessary for delay measurement can be reduced, and bandwidth strain in the network can be prevented.

Although embodiments of the present invention have been described so far, the present invention is not limited to the above embodiments, and various modifications can be made to them without departing from the scope of the present invention. In a case where the number, numerical quantity, quantity, range, and the like of each component are specified in the embodiments described above, the present invention is not limited to the numbers mentioned, unless they are explicitly stated or the numbers are clearly specified in principle. Further, the structures and the like described in the above embodiments are not necessarily essential to the present invention, unless it is explicitly stated or the present invention is clearly limited to them in principle.

### REFERENCE SIGNS LIST

1 network delay measurement system
2 delay measurement device
3 computer network
4 opposing terminal
branching device
21, 41 CPU
22, 42 hardware processing unit
23 delay measurement circuit
24 measurement packet generation unit
response packet reception unit
26 delay time calculation unit
27 transmission control unit
43 response circuit
44 buffer
45 bifurcating circuit
46 transmission timing control unit
47 standby time measurement unit
70 delay measurement device
71 computer network
72 opposing terminal

1. A network delay measurement system comprising:
a delay measurement device that includes: a general-purpose processor that operates according to a loaded program; and a delay measurement circuit that has a lower latency than the general-purpose processor, and operates according to a pre-installed circuit without use of the program; and
an opposing terminal that communicates with the delay measurement device via a computer network,
wherein:
the delay measurement circuit includes:
measurement packet generation circuitry that is pre-installed, generates a measurement packet, transmits the measurement packet to the opposing terminal, and stores a transmission time of the measurement packet; and
response packet reception circuitry that receives a response packet from the opposing terminal, and stores a reception time of the response packet,
one of the general-purpose processor or the delay measurement circuit includes delay time calculation circuitry that calculates a reciprocation delay time by subtracting the transmission time from the reception time, and
the opposing terminal includes response circuit that is pre-installed, and transmits the response packet when receiving the measurement packet.

2. The network delay measurement system according to claim 1, wherein:
the opposing terminal includes:
a buffer; and
a bifurcating circuit that transmits the received measurement packet to each of the response circuit and the buffer, and
the response circuit receives the measurement packet from the bifurcating circuit without use of the buffer, and transmits the response packet.

3. The network delay measurement system according to claim 1, wherein:
the measurement packet generation circuitry transmits the measurement packet in a broadcast or multicast manner.

4. The network delay measurement system according to claim 3, wherein:
the delay measurement device and the opposing terminal communicate in a time-division multiplexing manner,
the opposing terminal includes at least a first opposing terminal and a second opposing terminal,
the network delay measurement system further comprises uplink transmission control circuitry that determines an uplink transmission timing to avoid a collision between uplink transmissions from the first opposing terminal and the second opposing terminal to the delay measurement device,
the response circuit includes:
transmission timing control circuitry that performs the uplink transmission on a basis of the determined uplink transmission timing; and
standby time measurement circuitry that measures a standby time from generation of the response packet to arrival of an opportunity of the uplink transmission, and adds the standby time to the response packet, and
the delay time calculation circuitry calculates the reciprocation delay time by subtracting the transmission time at which the measurement packet has been transmitted and the standby time from the reception time at which the response packet has been received.

5. A network delay measurement method that uses
a delay measurement device that includes: a general-purpose processor that operates according to a loaded program; and a delay measurement circuit that has a lower latency than the general-purpose processor, and operates according to a pre-installed circuit without use of the program, and
an opposing terminal that communicates with the delay measurement device via a computer network, and includes a response circuit that operates according to a pre-installed circuit,
the network delay measurement method comprising:
a measurement packet generation step of generating a measurement packet, transmitting the measurement packet to the opposing terminal, and storing a transmission time of the measurement packet, using the delay measurement circuit;
a response packet transmission step of transmitting a response packet using the response circuit, when the opposing terminal receives the measurement packet;
a response packet reception step of receiving the response packet from the opposing terminal, and storing a reception time of the response packet, using the delay measurement circuit; and
a delay time calculation step of calculating a reciprocation delay time by subtracting the transmission time from the reception time, using one of the general-purpose processor or the delay measurement circuit.

6. The network delay measurement method according to claim 5, wherein:
the opposing terminal includes:
a buffer; and
a bifurcating circuit that transmits the received measurement packet to each of the response circuit and the buffer, and
the response packet transmission step includes receiving the measurement packet from the bifurcating circuit without use of the buffer, and transmitting the response packet.

7. A network delay measurement apparatus that communicates with an opposing terminal via a computer network,
the network delay measurement apparatus comprising:
a general-purpose processor that operates according to a loaded program; and
a delay measurement circuit that has a lower latency than the general-purpose processor, and operates according to a pre-installed circuit without use of the program,
wherein:
the delay measurement circuit includes:
a measurement packet generation circuitry that is pre-installed, generates a measurement packet, transmits the measurement packet to the opposing terminal, and stores a transmission time of the measurement packet; and
a response packet reception circuitry that receives a response packet from the opposing terminal, and stores a reception time of the response packet, and
one of the general-purpose processor or the delay measurement circuit includes a delay time calculation circuitry that calculates a reciprocation delay time by subtracting the transmission time from the reception time.

8. (canceled)
